(19) United States
(12) Patent Application Publication
(10) Pub. No.: US 2025/0111512 A1
(43) Pub. Date: Apr. 3, 2025

(54) MICROSCOPE SLIDE IMAGE-BASED MACHINE LEARNING IMAGE ANALYSIS FOR INFLAMMATORY BOWEL DISEASE

(71) Applicant: Genentech, Inc., South San Francisco, CA (US)

(72) Inventor: Alexis SCHERL, South San Francisco, CA (US)

(21) Appl. No.: 18/981,081

(22) Filed: Dec. 13, 2024

Related U.S. Application Data
(63) Continuation of application No. PCT/US2023/069504, filed on Jun. 30, 2023.
(60) Provisional application No. 63/387,467, filed on Dec. 14, 2022.
(60) Provisional application No. 63/358,019, filed on Jul. 1, 2022.

(51) Int. Cl. G06T 7/00; G06V 10/762; G06V 20/69

(52) U.S. Cl. CPC G06T 7/0012; G06V 10/762; G06V 20/695; G06V 20/698; G06T 2207/20021; G06T 2207/20081; G06T 2207/30024; G06T 2207/30028; G06V 2201/031

(57) ABSTRACT

A method includes determining, within an image of a biological sample from an intestine of a patient, a plurality of image patches depicting a portion of the biological sample. A plurality of bowel disease indication groups corresponding to a subset of the plurality of image patches may be determined based at least on the plurality of image patches. A group-level histological score for each bowel disease indication group of the plurality of bowel disease indication groups may be generated based at least on the subset of the plurality of image patches contained in each respective group. An aggregated histological score indicative of a disease burden in the intestine of the patient may be generated based on the generated group-level histological score for each bowel disease indication group. Related systems and computer program products are also provided.

### CROSS REFERENCE TO RELATED APPLICATIONS

The present application is a continuation of International Application No. PCT/US2023/069504, filed on Jun. 30, 2023, which claims priority to U.S. Provisional patent application Ser. No. 63/358,019, filed Jul. 1, 2022, and U.S. Provisional Patent Application No. 63/387,467, filed Dec. 14, 2022, the disclosures of which are hereby incorporated by reference in their entireties.

### TECHNICAL FIELD

The subject matter described herein relates generally to digital pathology and more specifically to microscope slide image-based machine learning image analysis for inflammatory bowel disease.

### INTRODUCTION

Inflammatory bowel disease (IBD), which includes the distinct entities of Crohn's Disease and Ulcerative Colitis (UC), is a common disease with a high rate of poor long-term outcomes in terms of steroid-dependence, hospitalization, and surgery, but has few effective treatment options. UC impacts the most superficial layer of the bowel and the mucosa, and invariably involves the rectum. UC can also variably extend proximally to involve some or all of the colon. The disease burden of IBD is challenging to objectively assess clinically, making it difficult to reliably determine the efficacy of various treatment options. As such, biologic insights into IBD and reliable and reproducible methods for assessing the pathophysiology and disease burden of IBD remains crucial for identifying effective new therapeutic treatments, improving patient monitoring, and/or the like.

### SUMMARY

Systems, methods, and articles of manufacture, including computer program products, are provided for image-based (e.g., whole scanned slide image-based) machine learning analysis for IBD. In some example embodiments, there is provided a system that includes at least one processor and at least one memory. The at least one memory may include program code that provides operations when executed by the at least one processor. The operations may include: determining, within an image of a biological sample from an intestine of a patient, a plurality of image patches. Each image patch of the plurality of image patches depicts a portion of the biological sample. The operations also include determining a plurality of bowel disease indication groups based at least on the plurality of image patches. Each bowel disease indication group of the plurality of bowel disease indication groups corresponds to a subset of the plurality of image patches. The operations also include generating a group-level histological score for each bowel disease indication group of the plurality of bowel disease indication groups, based at least on the subset of the plurality of image patches contained in each respective group. The operations also include generating an aggregated histological score for the biological sample based on the generated group-level histological score for each bowel disease indication group. The aggregated histological score is indicative of a disease burden in the intestine of the patient.

In another aspect, a computer-implemented method includes determining, within an image of a biological sample from an intestine of a patient, a plurality of image patches. Each image patch of the plurality of image patches depicts a portion of the biological sample. The method also includes determining a plurality of bowel disease indication groups based at least on the plurality of image patches. Each bowel disease indication group of the plurality of bowel disease indication groups corresponds to a subset of the plurality of image patches. The method also includes generating a group-level histological score for each bowel disease indication group of the plurality of bowel disease indication groups, based at least on the subset of the plurality of image patches contained in each respective group. The method also includes generating an aggregated histological score for the biological sample based on the generated group-level histological score for each bowel disease indication group. The aggregated histological score is indicative of a disease burden in the intestine of the patient.

In another aspect, there is provided a computer program product including a non-transitory computer readable medium storing instructions. The instructions may cause operations may executed by at least one data processor. The operations may include: determining, within an image of a biological sample from an intestine of a patient, a plurality of image patches. Each image patch of the plurality of image patches depicts a portion of the biological sample. The operations also include determining a plurality of bowel disease indication groups based at least on the plurality of image patches. Each bowel disease indication group of the plurality of bowel disease indication groups corresponds to a subset of the plurality of image patches. The operations also include generating a group-level histological score for each bowel disease indication group of the plurality of bowel disease indication groups, based at least on the subset of the plurality of image patches contained in each respective group. The operations also include generating an aggregated histological score for the biological sample based on the generated group-level histological score for each bowel disease indication group. The aggregated histological score is indicative of a disease burden in the intestine of the patient.

In some variations, one or more features disclosed herein including the following features can optionally be included in any feasible combination of the system, method, and/or non-transitory computer readable medium. In some variations, the group-level histological score and the aggregated histological score are each one of a Nancy Histological Index (NHI) score, a Robarts Histopathology Index (RHI) score, a Geboes Scale score, and a Global Histology Activity Score (GHAS).

In some variations, the group-level histological score and the aggregated histological score is at least one of a first score indicating no disease burden, a second score indicating low disease burden in the intestine of the patient, a third score indicating a moderate disease burden in the intestine of the patient, and a fourth score indicating a high disease burden in the intestine of the patient.

In some variations, the subset of the plurality of image patches is formed by at least clustering one or more similar image patches of the plurality of image patches based at least on one or more pixel-wise features.

In some variations, a presence of a first pixel-wise feature of the one or more pixel-wise features in the plurality of image patches is associated with a first possible histological score. An absence of the first pixel-wise feature is associated with a second possible histological score.

In some variations, the generating the group-level histological score includes assigning a higher attention score to a first image patch of the subset of the plurality of image patches than a second image patch of the subset of the plurality of image patches based at least on the presence of the first pixel-wise feature or the absence of the first pixel-wise feature. The group-level histological score is generated while determining a representational encoding of the subset of the plurality of image patches.

In some variations, the higher attention score indicates that a first pixel-wise feature of the first image patch contributes more to the representational encoding of the subset of the plurality of image patches than the second patch.

In some variations, the one or more pixel-wise features is representative of a presence in the biological sample of at least one of an erosion of tissue, a neutrophil, a lymphoid structure, a crypt abscess, and debris within an epithelium of the tissue.

In some variations, the one or more pixel-wise features includes at least one of a shape, a color, a size, a presence of a dye, and an intensity associated with a pixel of the image of the biological sample.

In some variations, the subset of the plurality of image patches includes a common pixel-wise feature of the one or more pixel-wise features.

In some variations, the group-level histological score is generated based at least on one or more of a quantity of the one or more pixel-wise features within the subset of the plurality of image patches and a distribution of the one or more pixel-wise features within the subset of the plurality of image patches.

In some variations, the clustering is performed by applying a cluster analysis technique.

In some variations, the cluster analysis technique includes one or more of a k-means clustering, a mean-shift clustering, a density-based spatial clustering of applications with noise (DBSCAN), an expectation-maximization (EM) clustering using Gaussian mixture models (GMM), and an agglomerative hierarchical clustering.

In some variations, the method includes generating a first visual representation of a reduced dimension representation of the plurality of image patches.

In some variations, the first visual representation includes one or more visual indicators configured to indicate a contribution of a pixel-wise feature to a possible group-level histological score.

In some variations, the first visual representation includes one or more visual indicators configured to provide a visual differentiation between image patches of the plurality of image patches indicating different possible histological scores.

In some variations, the first visual representation is generated by at least applying, to a pixel-wise representation of each image patch of the plurality of image patches, a dimensionality reduction technique.

In some variations, the dimensionality reduction technique includes one or more of a principal component analysis (PCA), a uniform manifold approximation and projection (UMAP), and a T-distributed Stochastic Neighbor Embedding (t-SNE).

In some variations, the group-level histological score and the aggregated histological score are each generated by applying at least one machine learning model trained to generate the group-level histological score and the aggregated histological score by at least determining a representational encoding of the subset of the plurality of image patches.

In some variations, the at least one machine learning model includes a multiple instance learning (MIL) model.

In some example embodiments, there is provided a system that includes at least one processor and at least one memory. The at least one memory may include program code that provides operations when executed by the at least one processor. The operations may include: receiving an image of a biological sample from an intestine of a patient. The image depicts a plurality of cells of the biological sample. The operations may include segmenting the received image into a plurality of portions. Each portion of the plurality of portions correspond to one cell of the plurality of cells. The operations may include identifying, based at least on the segmented image, a first spatial coordinate associated with each cell of the plurality of cells within the image. The operations may include identifying a first cell type associated with the first spatial coordinate. The operations may include generating, based at least on the first spatial coordinate and the first cell type, a visual representation including the image of the biological sample.

In some aspects, a computer-implemented method includes: receiving an image of a biological sample from an intestine of a patient. The image depicts a plurality of cells of the biological sample. The method may include segmenting the received image into a plurality of portions. Each portion of the plurality of portions correspond to one cell of the plurality of cells. The method may include identifying, based at least on the segmented image, a first spatial coordinate associated with each cell of the plurality of cells within the image. The method may include identifying a first cell type associated with the first spatial coordinate. The method may include generating, based at least on the first spatial coordinate and the first cell type, a visual representation including the image of the biological sample.

In some aspects, there is provided a computer program product including a non-transitory computer readable medium storing instructions. The instructions may cause operations may executed by at least one data processor. The operations may include: receiving an image of a biological sample from an intestine of a patient. The image depicts a plurality of cells of the biological sample. The operations may include segmenting the received image into a plurality of portions. Each portion of the plurality of portions correspond to one cell of the plurality of cells. The operations may include identifying, based at least on the segmented image, a first spatial coordinate associated with each cell of the plurality of cells within the image. The operations may include identifying a first cell type associated with the first spatial coordinate. The operations may include generating, based at least on the first spatial coordinate and the first cell type, a visual representation including the image of the biological sample.

In some variations, one or more features disclosed herein including the following features can optionally be included in any feasible combination of the system, method, and/or non-transitory computer readable medium.

In some variations, the identifying is further based at least on a plurality of annotations identifying a plurality of cell types depicted in a plurality of images of biological samples.

In some variations, the first cell type is at least one of a neutrophil, a plasma cell, a lymphocyte, an intraepithelial lymphocyte, an eosinophil, a Mast cell, a macrophage, a goblet cell, an enterocyte, an endothelial cell, a fibroblast, a smooth muscle cell, and an endothelial cell.

In some variations, the image further depicts a plurality of tissue regions of the biological sample.

In some variations, the method includes identifying, based at least on the segmented image, a second spatial coordinate associated with each tissue region of the plurality of tissue regions and a first tissue region type associated with the second spatial coordinate.

In some variations, the method includes generating, based at least on the second spatial coordinate and the first tissue region type, a second visual representation including the image of the biological sample.

In some variations, the tissue region type is at least one of an epithelium, a mucosa, a submucosa, a normal crypt, an infiltrated crypt, a lumen, a blood vessel, a lymphatic vessel, a lamina propria, a muscularis mucosa, a basal plasmacytosis, an ulcer, an erosion, a granulation tissue, an infiltrated crypt, a crypt abscess, a normal collagen, an abnormal collagen, a stroma, a subtype of stroma, a hyperplastic muscle, a fissure, an abscess, a normal adipose, an abnormal adipose, a serosa, and a serositis.

In some variations, the identifying the second spatial coordinate and the first tissue region type is further based at least on a second plurality of annotations identifying a plurality of tissue region types depicted in a plurality of images of biological samples.

In some variations, the identifying includes generating a metric indicating a confidence level associated with the identified first cell type for each cell of the plurality of cells.

In some variations, the method includes generating spatial tabular data including the first spatial coordinate associated with each cell of the plurality of cells within the image and the first cell type associated with the first spatial coordinate.

In some variations, the method includes generating a histological score for the biological sample based at least on the first spatial coordinate and the first cell type associated with the first spatial coordinate. The histological score is indicative of a disease burden in the intestine of the patient.

In some variations, the histological score is one of a Nancy Histological Index (NHI) score, a Robarts Histopathology Index (RHI) score, a Geboes Scale score, a Global Histology Activity Score (GHAS), a muscle hyperplasia score, and a fibrosis score.

In some variations, the first cell type includes a neutrophil.

In some variations, the histological score is further generated based on a spatial distribution of the plurality of cells identified as having the first cell type.

In some variations, the histological score is further generated based on a quantity of cells of the plurality of cells identified as having the first cell type meeting a threshold quantity of cells.

In some variations, the histological score is further generated based on a tissue region type of a plurality of tissue regions depicted in the image.

In some variations, the tissue region type is at least one of an erosion and an ulceration.

In some variations, the first spatial coordinate is two-dimensional.

In some variations, the method includes generating, based at least on the first spatial coordinate and the first cell type, an overlay indicating the first cell type at the first spatial coordinate. The overlay includes at least one of a mask, a color, and a pattern.

In some variations, the image is segmented by applying a machine learning model trained to perform per-cell segmentation and per-tissue region segmentation by at least assigning, to each pixel in the image, a cell segmentation label indicating whether the pixel is associated with a cell type of a cell depicted in the image and a tissue region label indicating whether the pixel is associated with a tissue region type of a tissue region depicted in the image.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to IBD and UC, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. The patent or application file contains at least one drawing executed in color. Copies of this patent or patent application publication with color drawing(s) will be provided by the Office upon request and payment of the necessary fee.

In the drawings,

FIG. 1 depicts a system diagram illustrating an example of a mucosal biopsy analysis digital pathology system, in accordance with some example embodiments;

FIG. 2 depicts an image of a biological sample from an intestine of a patient, in accordance with some example embodiments;

FIG. 3 depicts a portion of the image of FIG. 2 compared to an image of another biological sample from an intestine of a patient, in accordance with some example embodiments;

FIG. 4A depicts a screenshot illustrating an example of a visual representation, in accordance with some example embodiments;

FIG. 4B depicts a screenshot illustrating an example of a visual representation, in accordance with some example embodiments;

FIG. 4C depicts a screenshot illustrating an example of a visual representation, in accordance with some example embodiments;

FIG. 4D depicts a screenshot illustrating an example of a visual representation, in accordance with some example embodiments;

FIG. 5 depicts a bar graph, in accordance with some example embodiments;

FIG. 6 depicts a confusion matrix, in accordance with some example embodiments;

FIG. 7 depicts a confusion matrix, in accordance with some example embodiments;

FIG. 8 depicts a performance table, in accordance with some example embodiments;

FIG. 9 depicts an example end-to-end model, in accordance with some example embodiments;

FIG. 10A depicts a screenshot illustrating example visual representations, in accordance with some example embodiments;

FIG. 10B depicts a screenshot illustrating example visual representations, in accordance with some example embodiments;

FIG. 10C depicts a screenshot illustrating example visual representations, in accordance with some example embodiments;

FIG. 11 depicts a comparison matrix, in accordance with some example embodiments;

FIG. 12 depicts a flowchart illustrating an example of a process for image segmentation, in accordance with some example embodiments;

FIG. 13 depicts a flowchart illustrating an example of a process for histological score generation, in accordance with some example embodiments; and

FIG. 14 depicts a block diagram illustrating an example of a computing system, in accordance with some example embodiments.

When practical, similar reference numbers denote similar structures, features, or elements.

### DETAILED DESCRIPTION

IBD, including UC, has a high rate of poor long-term outcomes in terms of hospitalization and surgery, but has few effective treatment options. As noted, biologic insights into IBD and consistent methods for assessing clinical disease burden remains crucial for identifying effective new therapeutic treatments, improving patient monitoring, and/or the like. Historically, patient reported outcomes, such as stool frequency and rectal bleeding, as well as endoscopies (e.g., sigmoidoscopies), have been used to assess intestinal mucosal health. For example, endoscopies have been used to provide a visual assessment of a patient's intestinal mucosa using a camera passed through the intestinal lumen. While the endoscopic appearance of the intestine has been generally used to determine whether the intestine shows meaningful improvement in intestinal health (a concept previously termed mucosal healing), such visual assessments are highly subjective and variable. Further, there is often significant discordance between the endoscopic appearance of intestinal tissue and the actual inflammatory state of the tissue as can be seen at the microscopic level. For example, significant active microscopic inflammation can persist in endoscopically normal tissue; this disconnect highlights the importance of the histologic assessment of tissue biopsies taken from patients with IBD.

To address the pitfalls in using endoscopies to assess intestinal health, histological scores have been developed, validated, and implemented to more objectively categorize microscopic inflammation in the intestine. While many scoring systems exist, they all assess the presence of neutrophilic inflammation in tissue, which define active inflammation in the intestine. The extent of epithelial damage incurred by active inflammation (neutrophils) can also be a marker of tissue disease burden. For example, a categorical histological score can be assigned to a tissue sample. The categorical histological score can be categorized as severely active disease when there is epithelial erosion or ulceration in the tissue sample. When neutrophils infiltrate the epithelium, the score can be categorized as moderately active disease or mildly active disease, depending on neutrophil density and localization within the tissue compartments. In the absence of active disease, increased chronic (inactive) inflammation may be present, and would have an associated categorical score. The lowest score (generally a score of zero) would be in the absence of significant increases in either chronic or active inflammation.

However, conventional methods for assigning such categorical scores can be highly subjective, provide limited underlying data, and lack the granularity needed to be used for consistent and accurate assessment of intestinal health. Despite expensive and slow training of pathologist central readers, conventional methods for assigning such categorical scores can lead to a high level of variability such that the scores are not easily reproducible between readers (inter-reader variability) and by the same reader (intra-reader) over time for the same tissue sample, reducing a study's power to identify therapeutic efficacy. For example, certain cells, such as neutrophils, can be confused for eosinophils or lymphocytes, and vice versa. Similarly, the presence of ulceration can be driven by a small, detached, easily-overlooked tissue fragment. The variability can further increase when categorizing a lesion as either mild or moderate disease, which is a highly qualitative, subjective exercise. Thus, due to the prohibitive costs, high complexity of implementation, tremendous variability in scoring and interpretation, and the scarcity of unbiased data, conventional techniques for assessing intestinal health and assigning histological scores are impractical.

Consistent with embodiments of the current subject matter, a digital pathology platform may provide robust and reproducible data and categorical histology scores. In particular, the digital pathology platform described herein may identify relevant cells and features to quantitate the cellular content of each tissue sample and the corresponding spatial localization of the features within the tissue sample. The digital pathology platform may also generate an unbiased dataset, such as for hypothesis testing in clinical trials, determination of clinical response, and correlation with endoscopy, microbiome determination, gene sequencing, biomarkers, and/or the like. For example, the digital pathology platform may segment an image of a biological sample from an intestine of a patient into a plurality of cells, identify spatial coordinates associated with the plurality of cells and cell types and/or tissue region types associated with the spatial coordinates, and generate visual representations based on the identified spatial coordinates and cell types and/or tissue region types. These spatially-oriented and quantitative feature-and cell-specific segmentations can be extrapolated into categorical scores. Additionally, and/or alternatively, the digital pathology platform may employ an end-to-end model to perform machine learning enabled prediction of bowel disease indication groups and predict reproducible histological scores for the overall intestinal tissue sample. Thus, the digital pathology platform may generate comprehensive, quantitative unbiased data based on the tissue sample and predict a reproducible histological score based on the tissue sample.

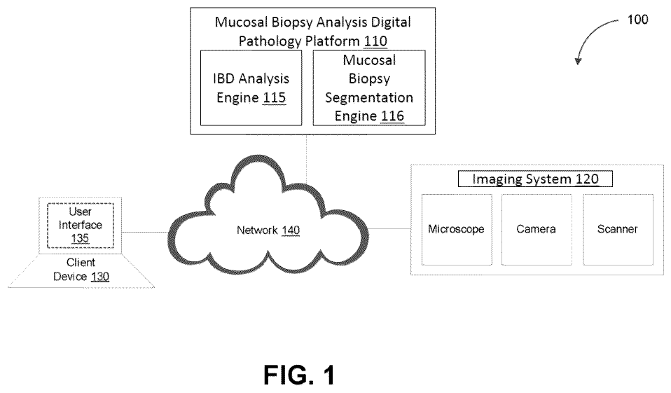

FIG. 1 depicts a system diagram illustrating an example of a digital pathology system 100, in accordance with some example embodiments. Referring to FIG. 1, the digital pathology system 100 may include a mucosal biopsy analysis digital pathology platform 110, an imaging system 120, and a client device 130. As shown in FIG. 1, the digital pathology platform 110, the imaging system 120, and the client device 130 may be communicatively coupled via a network 140. The network 140 may be a wired network and/or a wireless network including, for example, a local area network (LAN), a virtual local area network (VLAN), a wide area network (WAN), a public land mobile network (PLMN), the Internet, and/or the like. The imaging system 120 may include one or more imaging devices including, for example, a microscope, a digital camera, a whole slide scanner, a robotic microscope, and/or the like. The client device 130 may be a processor-based device including, for example, a workstation, a desktop computer, a laptop computer, a smartphone, a tablet computer, a wearable apparatus, and/or the like.

The digital pathology platform 110 may include an IBD analysis engine 115 and a mucosal biopsy segmentation engine 116. The analysis engine 115 and/or the segmentation engine 116 may perform one or more of the various processes and/or workflows described herein. The analysis engine 115 and the segmentation engine 116 may communicate with one another. For example, the segmentation engine 116 may perform at least a portion of a workflow and the analysis engine 115 may perform another portion of the workflow based on the first portion of the workflow performed by the segmentation engine 116, and vice versa. Thus, one or more aspects of the analysis engine 115 described herein may apply to the segmentation engine 116, and one or more aspects of the segmentation engine 116 may apply to the analysis engine 115. The digital pathology platform 110 may be hosted on cloud-based infrastructure such that the functionalities of the digital pathology platform 110 are accessible remotely, for example, as part of a web-based application, a native mobile application, a software-as-a-service (SaaS), and/or the like.

Referring again to FIG. 1, the digital pathology platform 110 may receive, such as from the imaging system 120, one or more images of a biological sample from an intestine of a patient. The one or more images of the biological sample may be whole slide images (WSI). In some embodiments, the one or more images of the biological sample are whole-scanned images of hematoxylin-and eosin-stained (H&E) formalin-fixed, paraffin-embedded (FFPE) tissue. The one or more images may be a microscope slide and/or an image of a microscope slide.

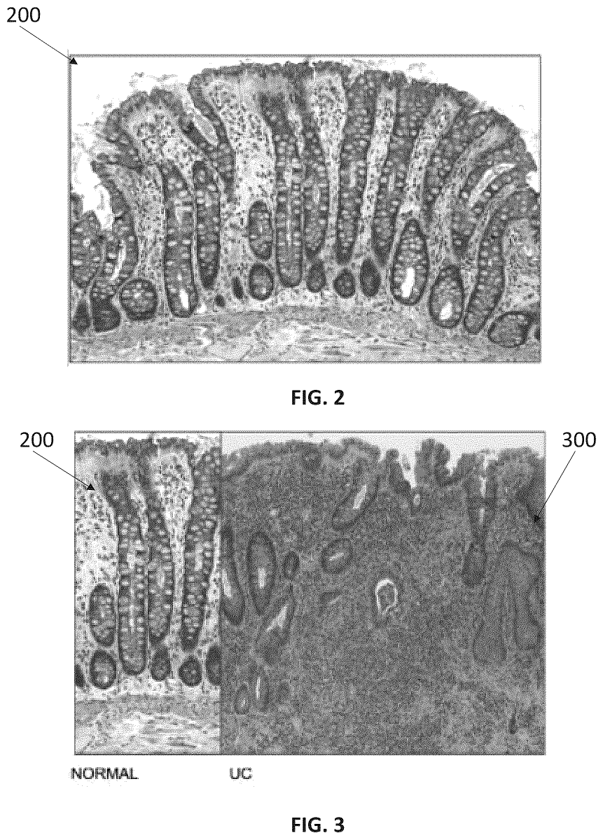

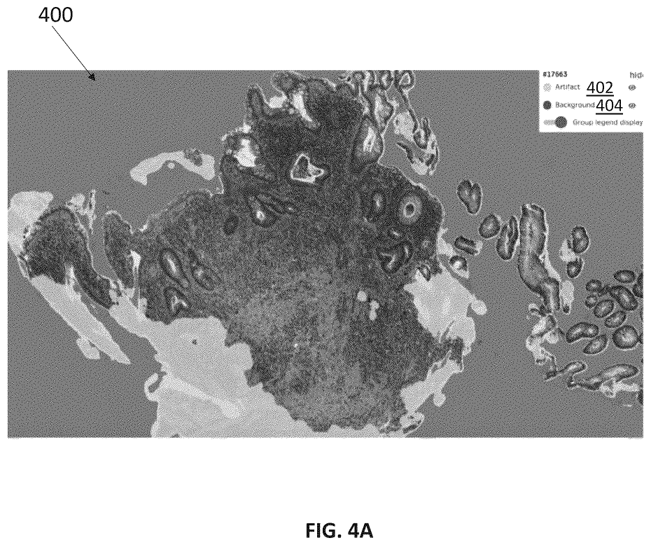

The one or more images may depict a plurality of cells of the biological sample, which may include a mucosal biopsy. For example, the biological sample from the intestine of the patient may include at least one neutrophil, plasma cell, lymphocyte, intraepithelial lymphocyte, eosinophil, Mast cell, macrophage, goblet cell, enterocyte, endothelial cell, fibroblast, smooth muscle cell, endothelial cell, and/or then like. The one or more images may additionally and/or alternatively depict a plurality of tissue regions, including an epithelium, a mucosa, a submucosa, a normal crypt, an infiltrated crypt, a lumen, a blood vessel, a lymphatic vessel, a lamina propria, a muscularis mucosa, basal plasmacytosis, an ulcer, erosion, granulation tissue, an infiltrated crypt, a crypt abscess, normal collagen, abnormal collagen, stroma, a subtype of stroma, a hyperplastic muscle, a fissure, an abscess, a normal adipose, an abnormal adipose, a serosa, serositis, and/or the like. Exemplary images are described at FIG. 2 and FIG. 3.

As noted above, there is generally a scarcity in unbiased data generated based on images, such as an image 200 of FIG. 2 and/or an image 300 of FIG. 3, of a biological sample from an intestine of a patient. Unbiased data includes data generated as a result of subjective analysis. For example, as noted, generated data may be biased based on the highly subjective and variable nature of visual assessments, categorical score assignment, and interpretation of images of tissue samples.

According to some example embodiments, the segmentation engine 116 generates a plurality of unbiased data based on such images. For example, the segmentation engine 116 may employ a machine learning model to detect various features of a mucosal biopsy sample, including a neutrophil, plasma cell, lymphocyte, intraepithelial lymphocyte, eosinophil, Mast cell, macrophage, goblet cell, enterocyte, endothelial cell, fibroblast, smooth muscle cell, endothelial cell, an epithelium, a mucosa, a submucosa, a normal crypt, an infiltrated crypt, a lumen, a blood vessel, a lymphatic vessel, a lamina propria, a muscularis mucosa, basal plasmacytosis, an ulcer, erosion, granulation tissue, an infiltrated crypt, a crypt abscess, normal collagen, abnormal collagen, stroma, a subtype of stroma, a hyperplastic muscle, a fissure, an abscess, a normal adipose, an abnormal adipose, a serosa, serositis, and/or the like. For instance, the segmentation engine 116 may generate spatial tabular data, heat map visualizations/overlays, predicted histological scores, and/or the like. Spatial tabular data includes at least one table having a plurality of rows corresponding to a particular cell type and/or tissue region type and a plurality of columns corresponding to at least one spatial coordinate associated with a cell having the particular cell type and/or tissue region type. The at least one spatial coordinate may be a two-dimensional spatial coordinate such that it identifies a two-dimensional location of at least a portion of the cell having the corresponding cell type and/or tissue region type. In other words, the spatial coordinate may include at least an x-coordinate and a y-coordinate associated with a location of at least a portion of the cell having the corresponding cell type and/or tissue region type.

The generated spatial tabular data, visualizations, predicted histological scores, and/or the like, helps to identify, locate, and quantify cell types and tissue region types, and therefore the disease burden, within the image with improved granularity. For example, the spatial tabular data allows for the localization of each cell and associated features depicted or detected in the image. The localization of the cells and associated features can provide key biomarkers indicative of disease burden in the intestine of the patient. For example, since the localization of the cells depicted in the image provides the two-dimensional location for each cell and/or tissue region, the distribution of cells within the image can be determined and used to efficiently and accurately evaluate the disease burden in the patient's intestinal biopsy. The spatial location, quantity, and distribution of the cells and/or tissue regions within the image can also be used to determine therapeutic efficacy of treatment options for treating IBD, such as UC. For example, the spatial location, quantity, and distribution may be associated with a particular level of disease burden (e.g., no, mild, moderate, severe, etc.). The spatial location, quantity, and distribution may be determined at various time points and compared to determine whether the spatial location, quantity, and distribution indicates an improvement in the disease burden in the intestine of the patient and to determine an effective treatment option for treating the disease.

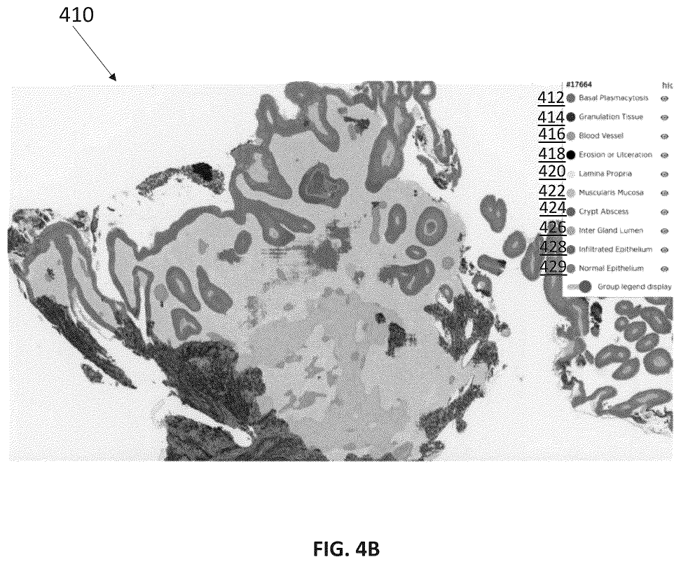

Based at least on the two-dimensional coordinates of each cell and/or tissue region, the segmentation engine 116 may generate a plurality of visual representations including the image of the biological sample. The visual representation may indicate a location of at least one cell type and/or tissue region type within the image. For example, the segmentation engine 116 may generate an overlay, such as at least one of a mask, a color, a pattern, a shade, and/or the like, associated with the cell type and/or tissue region type of the cells and/or tissue regions, respectively, that are depicted in the image of the biological sample. In some embodiments, the generated visual representations can be manipulated via a selection on the user interface 135 to indicate a spatial location of at least one cell and/or tissue region. For example, the generated visual representations can be manipulated via a selection on the user interface 135 to display the overlay associated with the selected cell type and/or tissue region type. Selection of a particular cell type and/or tissue region type may, in other words, show the location of the cell and/or tissue region having the corresponding cell type and/or tissue region type, respectively. Examples of such visual representations are provided at FIGS. 4A-4D.

Additionally and/or alternatively, the segmentation engine 116 may predict a histological score for the biological sample depicted in the image based at least on the two-dimensional coordinates of each cell and/or tissue region, the spatial distribution of the cells and/or tissue regions, a quantity of cells and/or tissue regions meeting a threshold quantity, detection of a particular cell type and/or tissue region, and/or localization of a particular cell type and/or tissue region type within the image. In some embodiments, the segmentation engine 116 provides the spatial tabular data and/or localization data to the analysis engine 115 for predicting the histological score. The predicted histological score may be indicative of a disease burden in the intestine of the patient. The predicted histological score may be at least one of a Nancy Histological Index (NHI) score, a Robarts Histopathology Index (RHI) score, a Geboes Scale score, a Global Histology Activity Score (GHAS), a muscle hyperplasia score, and a fibrosis score. While the predicted scores consistent with implementations of the current subject matter are referred to herein as being indicative of a disease burden in the intestine of the patient, the predicted scores may additionally and/or alternatively be indicative of a disease burden in the biopsy (e.g., biological sample) or image of the biopsy (e.g., image of the biological sample). The predicted score may still be indicative of an overall disease burden in the intestine of the patient. In some implementations, the predicted score is indicative of the overall disease burden in the intestine of the patient, such as based on a predicted score associated with one or more biopsies (e.g., biological samples) or images of the one or more biopsies (e.g., images of the biological samples).

In some embodiments, the categorical histological score can be scored from zero to four based at least on the spatial coordinates, distribution, and/or the like of the cells and/or tissue regions identified by the segmentation engine 116. For example, a grade 4 score may be predicted based on a determination of severely active disease, such as when there is erosion or ulceration in the tissue sample. A grade 3 score may be predicted based on a determination of moderately active disease or a grade 2 score may be predicted based on a determination of mildly active disease, such as when acute inflammatory cells are determined to have infiltrated the tissue sample epithelium. A grade 1 score may be predicted based on a determination of moderate or marked increase of chronic inflammatory cells are identified as infiltrating the tissue sample lamina propria with no acute inflammatory infiltration. A grade 0 score may be predicted based on a determination of no or mild increase in chronic inflammation when no significant disease activity is identified.

To generate the spatial tabular data, the visualizations, and/or the histological score, the segmentation engine 116 may segment the image of the biological sample into a plurality of portions corresponding to a cell and/or a tissue region. The segmentation engine 116 may segment the image in order to localize the individual cells and/or tissue regions that are present in the image depicting the biological sample. For example, the segmentation engine 116 may segment the image to localize individual cells including at least one of a neutrophil, a plasma cell, a lymphocyte, an intraepithelial lymphocyte, an eosinophil, a Mast cell, a macrophage, a goblet cell, an enterocyte, an endothelial cell, a fibroblast, a smooth muscle cell, an endothelial cell, and/or the like, and/or individual tissue regions, such as at least one of an epithelium, a mucosa, a submucosa, a normal crypt, an infiltrated crypt, a lumen, a blood vessel, a lymphatic vessel, a lamina propria, a muscularis mucosa, basal plasmacytosis, an ulcer, erosion, a granulation tissue, an infiltrated crypt, a crypt abscess, normal collagen, abnormal collagen, a stroma, a subtype of stroma, a hyperplastic muscle, a fissure, an abscess, a normal adipose, an abnormal adipose, a serosa, serositis, and/or the like.

For example, the segmentation engine 116 may perform per-cell and/or per-tissue region segmentation to assign, to each pixel within the image of the biological sample, a cell segmentation label identifying the cell to which the pixel belongs and/or a tissue region label identifying the tissue region to which the pixel belongs. Moreover, the task of per-cell and/or per-tissue region segmentation may include operating on high-dimensional image data, particularly when the images are high resolution and/or obtained at a high level of magnification.

In some example embodiments, the segmentation engine 116 may apply a variety of cell and/or tissue region segmentation techniques including, for example, watershed cell segmentation, deep learning-based cell segmentation, and/or the like. For example, the segmentation engine 116 may train and apply a machine learning model (e.g., a convolutional neural network and/or the like) to perform per-cell segmentation and/or per-tissue region segmentation. The machine learning model may perform per-cell segmentation by at least determining, for each pixel in the image, whether the pixel is a part of the background of the image or a part of a cell and/or tissue region depicted in the image (see FIG. 4A showing the segmented background). To do so, the machine learning model may further predict, for each pixel in the image, a probability or confidence level of the pixel being a part of a cell and/or a tissue region depicted in the image.

In some example embodiments, the segmentation engine 116 may apply multiple cell segmentation techniques to perform per-cell segmentation and localize the individual cells and/or tissue regions that are present in the image. In some cases, the segmentation label for a single pixel may be determined based on a first result of a first cell segmentation technique and a second result of a second cell segmentation technique. For example, the segmentation engine 116 may apply, to a pixel within the image, a first machine learning model to determine a first cell and/or tissue region segmentation label and a second machine learning model to determine a second cell and/or tissue region segmentation label. Moreover, the segmentation engine 116 may determine, based at least on the first cell and/or tissue region segmentation label and the second cell and/or tissue region segmentation label, a third cell and/or tissue region segmentation label for the pixel.

The segmentation engine 116 may identify at least one spatial coordinate based on the segmented image. For example, by at least localizing the cells and/or tissue regions, the segmentation engine 116 may identify at least one spatial coordinate associated with each cell and/or tissue region within the image. As described herein, the spatial coordinate may include an x-coordinate and/or a y-coordinate of the corresponding image. The identifying spatial coordinates may be stored for use in generating spatial tabular data, visualizations, histological scores, and/or the like.

The segmentation engine 116 may, upon localizing the individual cells and/or tissue regions present in the image, identify at least one cell type and/or tissue region type associated with the identified spatial coordinates. For example, the segmentation engine 116 may identify at least one cell type, including a neutrophil, a plasma cell, a lymphocyte, an intraepithelial lymphocyte, an eosinophil, a Mast cell, a macrophage, a goblet cell, an enterocyte, an endothelial cell, a fibroblast, a smooth muscle cell, an endothelial cell, and/or the like, and/or a tissue region, such as at least one of an epithelium, a mucosa, a submucosa, a normal crypt, an infiltrated crypt, a lumen, a blood vessel, a lymphatic vessel, a lamina propria, a muscularis mucosa, a basal plasmacytosis, an ulcer, an erosion, a granulation tissue, an infiltrated crypt, a crypt abscess, a normal collagen, an abnormal collagen, a stroma, a subtype of stroma, a hyperplastic muscle, a fissure, an abscess, a normal adipose, an abnormal adipose, a serosa, a serositis, and/or the like, as being associated with the identified pixel. The segmentation engine 116 may store the assigned cell type and/or tissue region type, in association with the corresponding pixel. For example, the segmentation engine 116 may store the assigned cell type and/or tissue region type with the corresponding pixel for use in generating spatial tabular data, visualizations, histological scores, and/or the like.

In some embodiments, the segmentation engine 116 identifies the cell type and/or the tissue region type corresponding to a particular pixel based on at least one annotation identifying a plurality of cell types and/or tissue region types in a plurality of images of biological samples. For example, the at least one annotation may be applied by a pathologist or other trained professional. The pathologist may provide the annotations to various images to identify each of the cell types and/or the tissue region types within the images. The machine learning model may be trained based at least in part on the annotations. In this manner, the machine learning model may include a supervised machine learning model.

In some embodiments, the segmentation engine 116 identifies the cell type and/or tissue region type corresponding to the particular pixel based on one or more features identified in the pixel. For example, the pixel may depict one or more features associated with a particular cell type and/or tissue region type. Based on the one or more features depicted in the pixel, the segmentation engine 116 assigns a cell segmentation label and/or a tissue region segmentation label.

As an example, FIG. 2 is an image 200 of a biological sample from an intestine of a patient. In particular, the image 200 is FFPE tissue that has been sectioned onto a glass slide and stained with hematoxylin and eosin (H&E). The image 200 depicts a normal or healthy colon mucosa free of disease. Image 200 depicts normal colonic mucosa as having epithelium, including crypts and surface epithelium, and lamina propria that includes sparse inflammatory cells such as plasma cells and lymphocytes. Here, the epithelial crypts have a uniform shape and size, with an approximately equal spatial distribution, indicating the lack of disease or disease burden.

FIG. 3 shows a portion of the image 200 compared to the image 300 of another biological sample from an intestine of a patient with UC. In the image 300, the lamina propria is filled with dense chronic inflammatory cells, such as lymphocytes and plasma cells, with the associated feature of basal plasmacytosis, which is a band of inflammation between the base of the crypts and the muscularis mucosa. Further, as shown in FIG. 3, the epithelium is irregular in size, shape, and distribution (e.g., architectural distortion). In addition to these features of chronic colitis, active inflammation is present, as defined by the presence of neutrophilic infiltrates. Epithelial damage is indicated by the presence of cryptitis, ulcers, and the like. The segmentation engine 116 can determine that the image 300 depicts chronic, active colitis.

FIG. 4A illustrates an example of a visual representation 400 including an image 401 of a biological sample according to some example embodiments. As shown in FIG. 4A, the visual representation 400 includes a first selectable element 402 and a second selectable element 404. Selection of the first selectable element 402 may cause an overlay to be displayed on the image 401 indicating an artifact in the visual representation 400. Selection of the second selectable element 404 may cause an overlay to be displayed on the image 401 indicating a background in the visual representation 400. The visual representation 400 may thus be used to more clearly indicate the features of the image 401 for evaluation.

FIG. 4B illustrates an example of a visual representation 410 including an image 411 (which may be the same as or different from image 401), of a biological sample according to some example embodiments. As shown in FIG. 4B, the visual representation 410 includes a first selectable element 412, a second selectable element 414, a third selectable element 416, a fourth selectable element 418, a fifth selectable element 420, a sixth selectable element 422, a seventh selectable element 424, an eighth selectable element 426, a ninth selectable element 428, and a tenth selectable element 429. In this example, the first selectable element 412, the second selectable element 414, the third selectable element 416, the fourth selectable element 418, the fifth selectable element 420, the sixth selectable element 422, the seventh selectable element 424, the eighth selectable element 426, the ninth selectable element 428, and the tenth selectable element 429 are associated with different cell types and/or tissue region types. For example, the first selectable element 412 is associated with basal plasmacytosis, the second selectable element 414 is associated with granulation tissue, the third selectable element 416 is associated with a blood vessel, the fourth selectable element 418 is associated with an erosion or ulceration, the fifth selectable element 420 is associated with lamina propria, the sixth selectable element 422 is associated with muscularis mucosa, the seventh selectable element 424 is associated with a crypt abscess, the eighth selectable element 426 is associated with a crypt lumen, the ninth selectable element 428 is associated with an infiltrated epithelium, and the tenth selectable element 429 is associated with a normal crypt. The first selectable element 412, the second selectable element 414, the third selectable element 416, the fourth selectable element 418, the fifth selectable element 420, the sixth selectable element 422, the seventh selectable element 424, the eighth selectable element 426, the ninth selectable element 428, and the tenth selectable element 429 can each be selected to display an overlay indicating the associated cell type and/or tissue region type.

FIG. 4C illustrates an example of a visual representation 430 including an image 431 of a biological sample according to some example embodiments. As shown in FIG. 4C, the visual representation 430 includes a first selectable element 432 and a second selectable element 434. In this example, the first selectable element 432 and the second selectable element 434 are associated with different cell types and/or tissue region types. For example, the first selectable element 432 is associated with a blood vessel lumen and the second selectable element 434 is associated with goblet cell cytoplasm. The first selectable element 432 and the second selectable element 434 can each be selected to display an overlay indicating the associated cell type and/or tissue region type.

FIG. 4D illustrates an example of a visual representation 440 including an image 441 of a biological sample according to some example embodiments. As shown in FIG. 4B, the visual representation 440 includes a first selectable element 442, a second selectable element 444, a third selectable element 446, a fourth selectable element 448, a fifth selectable element 450, a sixth selectable element 452, a seventh selectable element 454, and an eighth selectable element 456. In this example, the first selectable element 442, the second selectable element 444, the third selectable element 446, the fourth selectable element 448, the fifth selectable element 450, the sixth selectable element 452, the seventh selectable element 454, and the eighth selectable element 456 are associated with different cell types and/or tissue region types. For example, the first selectable element 442 is associated with a goblet cell nucleus, the second selectable element 444 is associated with a epithelial non-goblet cell enterocyte, the third selectable element 446 is associated with an intraepithelial lymphocyte, the fourth selectable element 448 is associated with a lymphocyte non-intraepithelial, the fifth selectable element 450 is associated with a plasma cell, the sixth selectable element 452 is associated with a eosinophil, the seventh selectable element 454 is associated with a neutrophil, and the eighth selectable element 426 is associated with other cells. The first selectable element 442, the second selectable element 444, the third selectable element 446, the fourth selectable element 448, the fifth selectable element 450, the sixth selectable element 452, the seventh selectable element 454, and the eighth selectable element 456 can each be selected to display an overlay indicating the associated cell type and/or tissue region type.

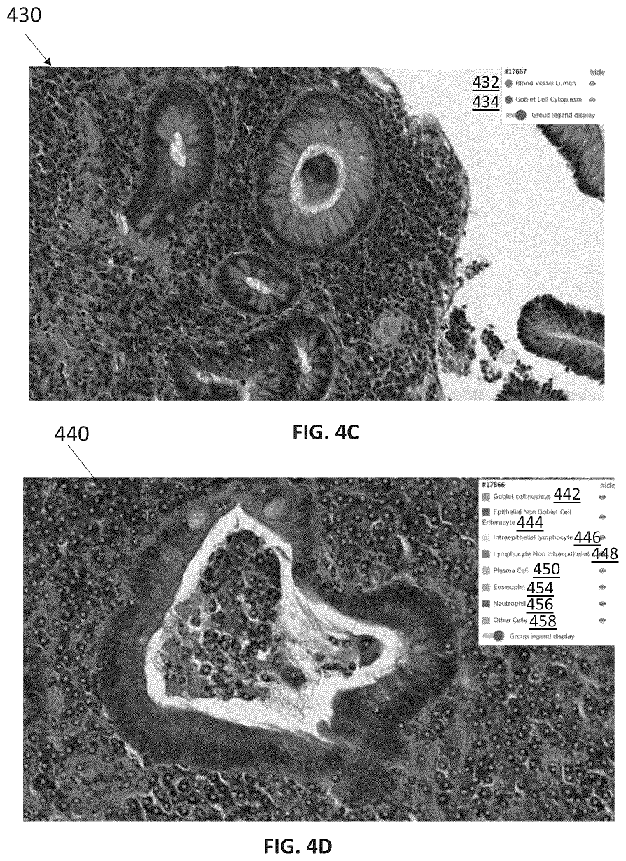

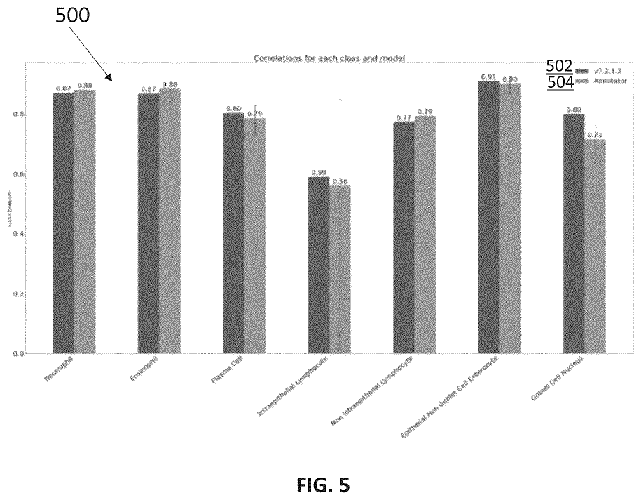

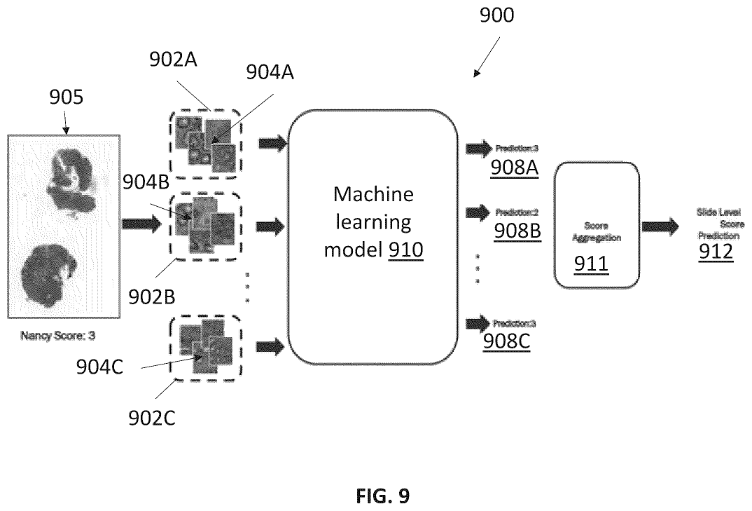

FIG. 5 illustrates an example bar graph 500 according to some example embodiments. The bar graph 500 compares the cell segmentation labels and/or the tissue region segmentation labels generated by the segmentation engine 116 (see 502) for a group of 240 images to manual annotations provided by five pathologists (see 504) for those images. As shown in the bar graph 500, the cell segmentation labels and/or the tissue region segmentation labels generated by the segmentation engine 116 positively correlated with the manual annotations for each of the cell types and/or tissue region types. FIG. 6 depicts a confusion matrix that further shows positive correlations between the cell segmentation labels and/or the tissue region segmentation labels generated by the segmentation engine 116 and manually applied annotations. Likewise, FIG. 8 shows in the second column that the segmentation engine 116 consistently and accurately identified cell segmentation labels and/or the tissue region segmentation labels. For example, as shown in FIG. 8, the model employed by the segmentation engine 116 to identify cell segmentation labels and/or the tissue region segmentation labels associated with the pixels in the image had a weighted kappa of 0.80 and a Spearman correlation of 0.79.

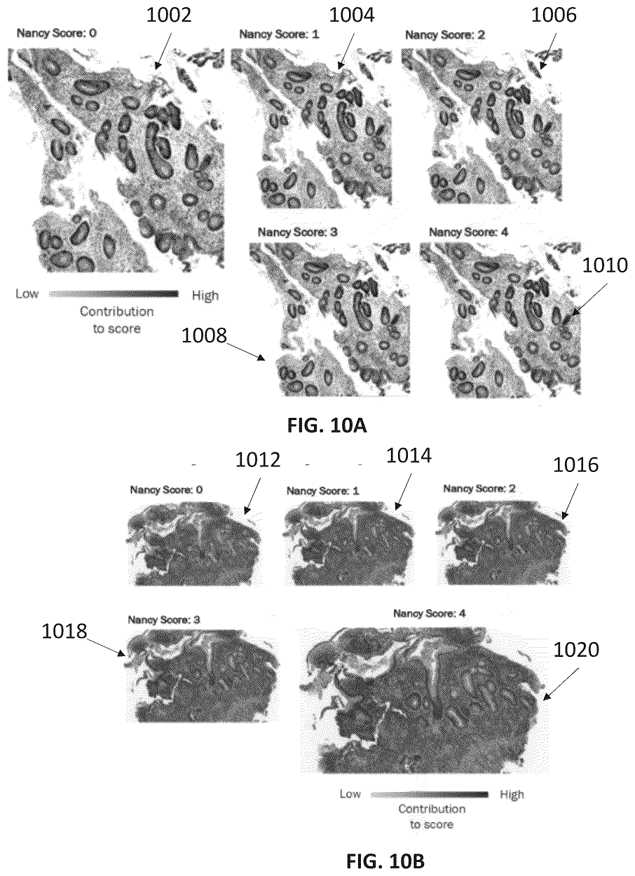

FIG. 9 illustrates an end-to-end model 900 according to some example embodiments. The end-to-end model 900 may be implemented at least in part by the analysis engine 115. The analysis engine 115 may implement the end-to-end model 900 to generate an aggregated histological score (e.g., an overall score) for a biological sample depicted in an image, such as a whole slide scanned image of H&E-stained FFPE tissue, and/or the like. As described herein, the histological score, such as the aggregated histological score, is histological score is a Nancy Histological Index (NHI) score, a Robarts Histopathology Index (RHI) score, a Geboes Scale score, a Global Histology Activity Score (GHAS) and/or the like. In some examples, the histological score includes a first score indicating no disease burden (e.g., free of disease) or a low disease burden in the intestine of the patient, a second score indicating a mild disease burden in the intestine of the patient, a third score indicating a moderate disease burden in the intestine of the patient, a fourth score indicating a high disease burden, and so on. As noted, while the predicted scores consistent with implementations of the current subject matter are referred to herein as being indicative of a disease burden in the intestine of the patient, the predicted scores may additionally and/or alternatively be indicative of a disease burden in the biopsy (e.g., biological sample) or image of the biopsy (e.g., image of the biological sample). The predicted score may still be indicative of an overall disease burden in the intestine of the patient. In some implementations, the predicted score is indicative of the overall disease burden in the intestine of the patient, such as based on a predicted score associated with one or more biopsies (e.g., biological samples) or images of the one or more biopsies (e.g., images of the biological samples).

As noted herein, scores have been conventionally assigned to images of biological samples. However, such scores have generally been unreliable due at least in part to the subjectivity involved when assigning the scores, the intra-and inter-reader variability in assigning scores to the same biological sample, and the variability in interpreting and defining various aspects of the biological sample. The analysis engine 115 may employ the end-to-end model 900 to generate a reliable and reproducible histological score for the biological sample depicted in the image. Thus, the analysis engine 115 may reduce the variability that has previously been associated with histological scores, which improves the ability to rely on the histological scores and the ability to more accurately assess and/or treat the health of the patient (e.g., disease burden in the intestine of a patient).

The end-to-end model 900 may include one or more machine learning models 910, such as a multiple instance machine learning model, among other models. The analysis engine 115 may apply the one or more machine learning models 910 to determine, based at least on an image of a biological sample depicting at least a portion of an intestine of the patient, the histological score indicating the level of disease burden in the portion of the intestine depicted in the image. For example, as shown in FIG. 9, the analysis engine 115 may determine, within an image, such as the image 200 and/or the image 300, of at least a portion of an intestine of a patient, one or more bowel disease indication groups, including, for example, a first bowel disease indication group 902A, a second bowel disease indication group 902B, a third bowel disease indication group 902C, and/or the like.

The one or more bowel disease indication groups include a plurality of image patches, each depicting a portion of the biological sample. For example, FIG. 9 shows an image patch 905 of the plurality of image patches. The image patch 905 may depict at least a portion of the cells present in the biological sample.

Referring to FIG. 9, the first bowel disease indication group 902A, the second bowel disease indication group 902B, and the third bowel disease indication group 902C may each include a subset of the plurality of image patches representing one or more portions of the biological sample depicted in the image. For example, the first bowel disease indication group 902A includes a first plurality of image patches 904A, the second bowel disease indication group 902B includes a second plurality of image patches 904B, and the third bowel disease indication group 902C includes a third plurality of image patches 904C. Each of the first plurality of image patches 904A, the second plurality of image patches 904B, and the third plurality of image patches 904C includes one or more portions of the biological sample depicted in the image. Accordingly, the first plurality of image patches 904A, the second plurality of image patches 904B, and the third plurality of image patches 904C may each be subsets of the plurality of image patches.

In some embodiments, the analysis engine 115 may exclude, from histological score generation, image patches that do not depict an above threshold quantity of the cells and/or portions of the cells present in the biological sample. Examples of image patches excluded from histological score generation may include image patches with an above-threshold proportion of a background of the image, image patches with a below-threshold mean color channel variance (e.g., gray colored tiles), and/or the like.

The analysis engine 115 may form the subset of the plurality of image patches (e.g., the first plurality of image patches 904A, the second plurality of image patches 904B, the third plurality of image patches 904C, and/or the like) by at least clustering one or more similar image patches of the plurality of image patches based at least on a pixel-wise representation of the plurality of image patches including one or more pixel-wise features. The analysis engine 115 may form the first bowel disease indication group 902A, the second bowel disease indication group 902B, and the third bowel disease indication group 902C by at least clustering one or more image patches having similar pixel-wise features. In some embodiments, the analysis engine 115 forms the bowel disease burden groups by at least clustering the image patches based on the pixel-wise features such that each bowel disease indication group includes a distribution of image patches representative of the overall image of the biological sample.

In some embodiments, the analysis engine 115 (e.g., the machine learning model 910) includes a feature extraction mechanism to extract the one or more pixel-wise features from the plurality of image patches, such as from the pixel-wise representation of the plurality of image patches. The pixel-wise features may be associated with a particular pixel of the image. The pixel-wise features may include a feature associated with a particular cell and/or tissue region. For example, the pixel-wise features may include a shape, a color, a size, a presence of a dye, an intensity, and/or the like, associated with the particular pixel of the image of the biological sample. The pixel-wise features may indicate a presence in the biological sample of a tissue region type and/or a cell type, such as, for example, an erosion of tissue, a neutrophil, a lymphoid structure, a crypt abscess, debris within an epithelium of the tissue, and/or the like.

The analysis engine 115 may form the subset of the plurality of image patches in each of the bowel disease burden groups by applying, to the pixel-wise representation of the image of the biological sample, a cluster analysis technique such as a k-means clustering, a mean-shift clustering, a density-based spatial clustering of applications with noise (DBSCAN), an expectation-maximization (EM) clustering using Gaussian mixture models (GMM), an agglomerative hierarchical clustering, and/or the like. In doing so, the analysis engine 115 may identify a quantity of clusters that maximizes the intra-cluster correlation amongst the members of each cluster.

Additionally and/or alternatively, the analysis engine 115 identifies the bowel disease indication groups by applying, to the pixel-wise representation of each image patch in the image, a dimensionality reduction technique, such as a principal component analysis (PCA), a uniform manifold approximation and projection (UMAP), a T-distributed Stochastic Neighbor Embedding (t-SNE), and/or the like. The resulting reduced dimension representation of the image patches in the image may correspond to a projection of the pixel-wise representation of each tile onto a lower dimensional subspace.

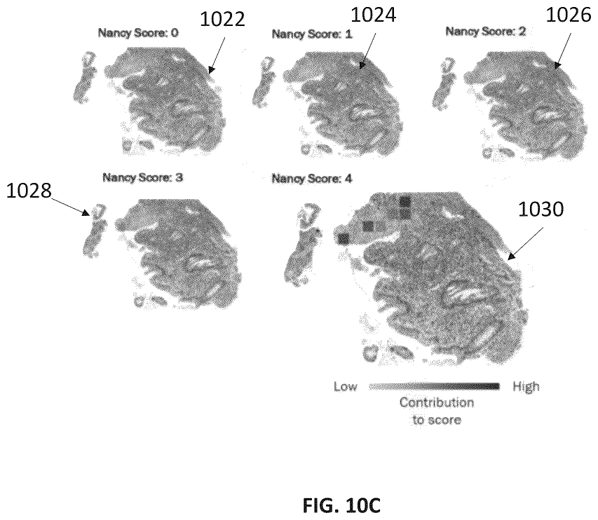

The analysis engine 115 may generate one or more visual representations of a reduced dimension representation of the plurality of image patches. The one or more visual representations may include one or more visual indicators (e.g., overlays, colors, masks, etc.) showing the different pixel-wise features and/or indicating a contribution of a pixel-wise feature to a possible group-level histological score (see FIGS. 10A-10C). The one or more visual indicators provide a visual differentiation between image patches indicating different possible histological scores.

Referring again to FIG. 9, the analysis engine 115, via the machine learning model 910 generates a group-level histological score for each bowel disease indication group of the plurality of bowel disease indication groups, based at least on the subset of the plurality of image patches contained in each respective group. In other words, the analysis engine 115 may generate the group-level histological score by at least applying one or more machine learning models to predict the histological score for each bowel disease indication group of image patches. The one or more machine learning models may be trained to generate the group-level histological score by at least determining a representational encoding of the subset of the plurality of image patches. In some embodiments, the at least one machine learning model is trained on the cell segmentation labels and tissue region segmentation labels generated by the segmentation engine 116, and/or based on the annotations provided by the pathologist. Referring to FIG. 9, the machine learning model 910 may generate a first group-level histological score 908A corresponding to the first bowel disease indication group 902A, a second group-level histological score 908B corresponding to the second bowel disease indication group 902B, and a third group-level histological score 908C corresponding to the third bowel disease indication group 902C.

In some embodiments, the group-level histological score may be generated while determining the representational encoding of the subset of the plurality of image patches. For example, the machine learning model 910 may include an attention mechanism configured to assign, to each image patch an attention score representative of a contribution (e.g., a relevance) of the pixel-wise features in each image patch to the group-level histological score of each corresponding bowel disease indication group. Accordingly, the attention mechanism of the machine learning model 910 may assign a higher attention score to a first image patch of the subset of the plurality of image patches than a second image patch of the subset of the plurality of image patches based at least on the presence of the first pixel-wise feature or the absence of the first pixel-wise feature. The higher attention score indicates that a first pixel-wise feature of the first image patch contributes more to the representational encoding of the subset of the plurality of image patches than the second patch.

In some example embodiments, the analysis engine 115 may generate, for display in the user interface 135 at the client device 130, for example, one or more visual representations showing the contribution of particular pixel-wise features to a particular group-level histological score and the associated attention score. The one or more visual representations may include an overlay showing the image patch-level contributions for each group-level histological score. Generally, the group-level histological score and/or the aggregated histological score prediction may be driven by a greater number of image patches with high contribution for a given histological score.

For example, FIG. 10A shows a first visual representation 1002 corresponding to a first histological score indicative of low disease burden, a second visual representation 1004 corresponding to a second histological score indicative of mild or marked increase in disease burden, a third visual representation 1006 corresponding to a third histological score indicative of mild disease burden, a fourth visual representation 1008 corresponding to a fourth histological score indicative of moderate disease burden, and a fifth visual representation 1010 corresponding to a fifth histological score indicative of high disease burden. As shown, the second visual representation 1004 shows a greater number of image patches with high contribution than the first visual representation 1002, the third visual representation 1006 shows a greater number of image patches with high contribution than the second visual representation 1004 and/or the first visual representation 1002, the fourth visual representation 1008 shows a greater number of image patches with high contribution than the first visual representation 1002, the second visual representation 1004, and the third visual representation, and the fifth visual representation 1010 shows a greater number of image patches with high contribution than the first visual representation 1002, the second visual representation 1004, the third visual representation 1006, and the fourth visual representation 1008.

As another example, FIG. 10B shows a first visual representation 1012 corresponding to a first histological score indicative of low disease burden, a second visual representation 1014 corresponding to a second histological score indicative of mild or marked increase in disease burden, a third visual representation 1016 corresponding to a third histological score indicative of mild disease burden, a fourth visual representation 1018 corresponding to a fourth histological score indicative of moderate disease burden, and a fifth visual representation 1020 corresponding to a fifth histological score indicative of high disease burden. As shown, the second visual representation 1014 shows a greater number of image patches with high contribution than the first visual representation 1012, the third visual representation 1016 shows a greater number of image patches with high contribution than the second visual representation 1014 and/or the first visual representation 1012, the fourth visual representation 1018 shows a greater number of image patches with high contribution than the first visual representation 1012, the second visual representation 1014, and the third visual representation, and the fifth visual representation 1020 shows a greater number of image patches with high contribution than the first visual representation 1012, the second visual representation 1014, the third visual representation 1016, and the fourth visual representation 1018.

As another example, FIG. 10C shows a first visual representation 1022 corresponding to a first histological score indicative of low disease burden, a second visual representation 1024 corresponding to a second histological score indicative of mild or marked increase in disease burden, a third visual representation 1026 corresponding to a third histological score indicative of mild disease burden, a fourth visual representation 1028 corresponding to a fourth histological score indicative of moderate disease burden, and a fifth visual representation 1030 corresponding to a fifth histological score indicative of high disease burden. As shown, the second visual representation 1024 shows a greater number of image patches with high contribution than the first visual representation 1022, the third visual representation 1026 shows a greater number of image patches with high contribution than the second visual representation 1024 and/or the first visual representation 1022, the fourth visual representation 1028 shows a greater number of image patches with high contribution than the first visual representation 1022, the second visual representation 1024, and the third visual representation, and the fifth visual representation 1030 shows a greater number of image patches with high contribution than the first visual representation 1022, the second visual representation 1024, the third visual representation 1026, and the fourth visual representation 1028.

Additionally and/or alternatively, the machine learning model 910 generates the group-level histological score based at least a quantity of the one or more pixel-wise features within the subset of the plurality of image patches, a distribution of the one or more pixel-wise features within the subset of the plurality of image patches, and/or the like.

Referring to FIG. 9, the analysis engine 115 may, at 911, generate an aggregated histological score 912 for the biological sample based on the generated group-level histological score for each bowel disease indication group. The aggregated histological score is indicative of a disease burden in the intestine of the patient and may be the overall score predicted for the overall image of the biological sample. In some embodiments, the analysis engine 115 generates the aggregated histological score 912 by at least applying a machine learning model, such as the machine learning model 910 or another machine learning model trained to determine the overall histological score based on the generated group-level histological scores. In some embodiments, the analysis engine 115 generates the aggregated histological score 912 by at least determining an average of the generated group-level histological scores (e.g., the first group-level histological score 908A, the second group-level histological score 908B, the third group-level histological score 908C, and so on). In some embodiments, the analysis engine 115 averages the group-level histological scores by applying a weight to at least one of the group-level histological scores. For example, the analysis engine 115 may weight one or more group-level histological scores associated with one or more bowel disease indication groups and/or one or more image patches that include one or more pixel-wise features and/or a threshold quantity of pixel-wise features indicated as having a higher contribution to the aggregated histological score. The analysis engine 115 may aggregate the group-level histological scores to generate the aggregated histological score 912 via one or more other aggregation techniques.

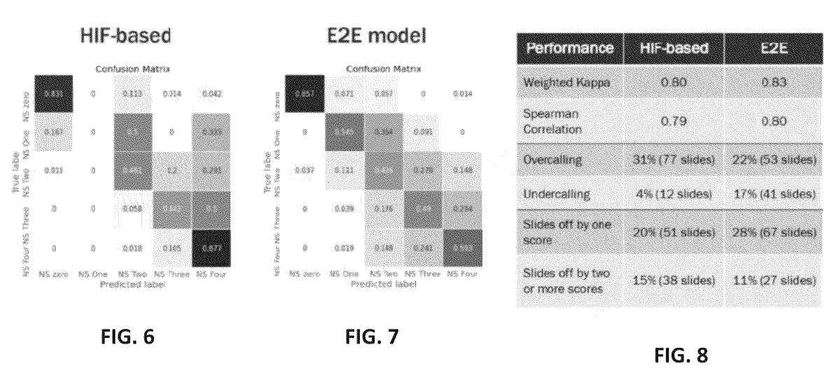

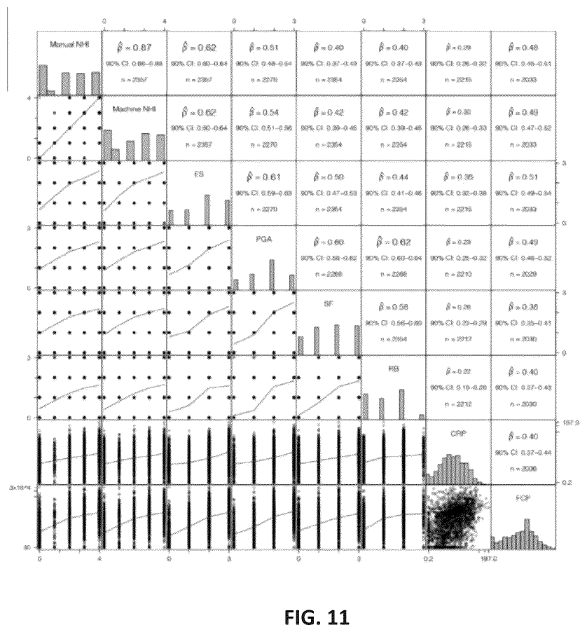

FIG. 7 depicts a confusion matrix that further shows positive correlations between the aggregated histological score generated by the analysis engine 115 and manually assigned histological scores. Likewise, FIG. 8 shows in the third column that the analysis engine 115 consistently and accurately generated histological scores at the slide-level and bowel disease burden group level. For example, as shown in FIG. 8, the model employed by the analysis engine 115 to generate an aggregated histological score had a weighted kappa of 0.83 and a Spearman correlation of 0.80. Further, FIG. 11 shows a positive correlation between the end-to-end model employed by the analysis engine 115 and scores, biomarkers, and other tests, such as a manual NHI score, a machine NHI score, an endoscopic subscore(ES), a physician's global assessment (PGA), a stool frequency (SF) biomarker, a rectal bleeding (RB) biomarker, c-reactive protein (CRP) biomarker, and the fecal calprotectin (FCP) biomarker.

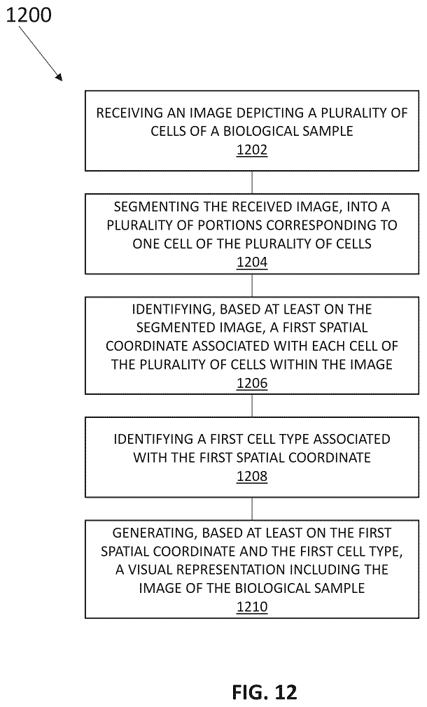

FIG. 12 depicts a flowchart illustrating an example of a process 1200 for cell-segmentation and/or tissue region segmentation, in accordance with some example embodiments. The process 1200 may be implemented by the analysis engine 115, the segmentation engine 116, the digital pathology platform 110, and/or other components therein.

At 1202, the segmentation engine 116 receives an image of a biological sample from an intestine of a patient. The image may depict a plurality of cells of the biological sample. The image may further depict a plurality of tissue regions of the biological sample. The image may include a whole-slide image, such as a scanned image of H&E-stained FFPE tissue.

At 1204, the segmentation engine 116 segments the received image into a plurality of portions. Each portion of the plurality of portions corresponds to one cell of the plurality of cells and/or one tissue region of a plurality of tissue regions. For example, the segmentation engine 116 may segment the image by applying a machine learning model trained to perform per-cell segmentation and per-tissue segmentation. The segmentation engine 116 may assign, to each pixel in the image, a cell segmentation label indicating whether the pixel is associated with a cell type of a cell depicted in the image and a tissue region label indicating whether the pixel is associated with a tissue region type of a tissue region depicted in the image. In some embodiments, the image is manually annotated with a plurality of annotations identifying a plurality of cell types and a plurality of tissue region types.

At 1206, the segmentation engine 116 identifies a first spatial coordinate associated with each cell of the plurality of cells within the image based at least on the segmented image. The segmentation engine 116 may additionally and/or alternatively identify a second spatial coordinate associated with each tissue region of the plurality of tissue regions within the image based at least one the segmented image. The first spatial coordinate and/or the second spatial coordinate may be two-dimensional.

At 1208, the segmentation engine 116 identifies a first cell type associated with the first spatial coordinate. The first cell type is at least one of a neutrophil, a plasma cell, a lymphocyte, an intraepithelial lymphocyte, an eosinophil, a Mast cell, a macrophage, a goblet cell, an enterocyte, an endothelial cell, a fibroblast, a smooth muscle cell, and an endothelial cell. Additionally and/or alternatively, the segmentation engine 116 identifies a first tissue region type associated with the second spatial coordinate. The tissue region type is at least one of an epithelium, a mucosa, a submucosa, a normal crypt, an infiltrated crypt, a lumen, a blood vessel, a lymphatic vessel, a lamina propria, a muscularis mucosa, a basal plasmacytosis, an ulcer, an erosion, a granulation tissue, an infiltrated crypt, a crypt abscess, a normal collagen, an abnormal collagen, a stroma, a subtype of stroma, a hyperplastic muscle, a fissure, an abscess, a normal adipose, an abnormal adipose, a serosa, and a serositis.

In some embodiments, the segmentation engine 116 identifies the first cell type based on a plurality of annotations identifying a plurality of cell types depicted in a plurality of images of biological samples. For example, the plurality of annotations may be manually applied by one or more pathologists and/or may be generated by the digital pathology platform 110. Likewise, the segmentation engine 116 may identify the first tissue region type based on a second plurality of annotations identifying a plurality of tissue region types depicted in a plurality of images of biological samples. The second plurality of annotations may be manually applied by one or more pathologists and/or may be generated by the digital pathology platform 110. In some embodiments, the segmentation engine 116 generates a metric indicating a confidence level associated with the identified first cell type for each cell of the plurality of cells and/or the identified first tissue region type for each tissue region of the plurality of tissue regions.

At 1210, the segmentation engine 116 generates a visual representation including the image of the biological sample, based at least on the first spatial coordinate and the first cell type. The segmentation engine 116 may further generate the visual representation based at least on the second spatial coordinate and the first tissue region type. The segmentation engine 116 may generate an overlay indicating the first cell type at the first spatial coordinate and/or the first tissue region type at the second spatial coordinate. The overlay may include at least one a mask, a color, a pattern, and/or the like.

Additionally and/or alternatively, the segmentation engine 116 generates spatial tabular data including the first spatial coordinate associated with each cell of the plurality of cells within the image and the first cell type associated with the first spatial coordinate. The segmentation engine 116 may generate spatial tabular data including the second spatial coordinate associated with each tissue region of the plurality of tissue regions within the image and the first tissue region type associated with the second spatial coordinate. The spatial tabular data may provide localization for each of the cells and/or tissue regions within the image. The spatial tabular data may be stored and used to generate the visual representation and/or a histological score.

Additionally and/or alternatively, the segmentation engine 116 generates a histological score for the biological sample based at least on the first spatial coordinate and the first cell type associated with the first spatial coordinate, and/or the second spatial coordinate and the first tissue region type associated with the second spatial coordinate. In some embodiments, the segmentation engine 116 communicates with the analysis engine 115 to generate the histological score.

The histological score is indicative of a disease burden in the intestine of the patient. The histological score includes one of a Nancy Histological Index (NHI) score, a Robarts Histopathology Index (RHI) score, a Geboes Scale score, a Global Histology Activity Score (GHAS), a muscle hyperplasia score, a fibrosis score, and/or the like. The histological score may be generated based on a spatial distribution of the plurality of cells identified as having the first cell type and/or a spatial distribution of the plurality of tissue regions identified as having the first tissue region type. Additionally and/or alternatively, the histological score is generated based on a quantity of cells of the plurality of cells identified as having the first cell type meeting a threshold quantity of cells. Additionally and/or alternatively, the histological score is generated based on a tissue region type of a plurality of tissue regions depicted in the image, such as when the tissue region type is an erosion and/or an ulceration.

Accordingly, the digital pathology platform 110 may efficiently generate unbiased localization data, such as spatial tabular data, and other data describing images of biological samples that can be used to generate visual representations, predict cell and/or tissue regions within the images of the biological samples, generate histological scores, and/or the like.

In some embodiments, the spatial tabular data, the visualizations, and/or the histological score generated by segmentation engine 116 may be used to compute a categorical histological score. For example, a graph neural network (GNN) may be implemented by analysis engine 115 to receive the spatial tabular data, the visualizations, and/or the predicted histological scores (e.g., Nancy score) and output a categorical histological score (e.g., a grade of 0-4). In one or more examples, the GNN may be trained to learn associations between the spatial tabular data and the categorical scores. Analysis engine 115 may obtain the spatial tabular data, visualization, and the predicted histological scores and input this data to the trained GNN to obtain a categorical score for a given image. Thus, features extracted, such as the spatial tabular data, can be connected to the molecular data of the tissue sample depicted by the images. The molecular data/markers can then be related to phenotype to make assessments on inflammation, which can further support diseases burden in the IBD analysis. In some embodiments, the spatial tabular data may be clustered together using the trained GNN to predict a categorical score. The spatial tabular data comprises a multifactorial data and the GNN can be used to condense the data down by identifying patterns and relationships between the data.

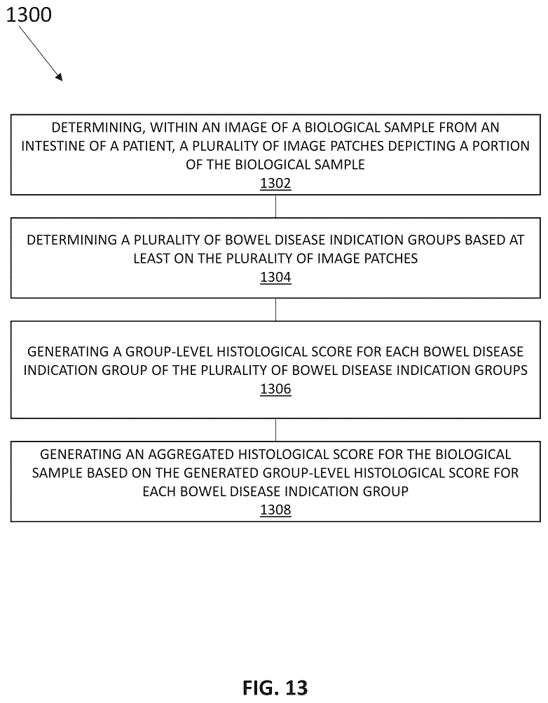

FIG. 13 depicts a flowchart illustrating an example of a process 1300 for histological score generation, in accordance with some example embodiments. The process 1300 may be implemented by the analysis engine 115, the segmentation engine 116, the digital pathology platform 110, and/or other components therein.

At 1302, the analysis engine 115 may determine a plurality of image patches within an image of a biological sample from an intestine of a patient. Each image patch of the plurality of image patches depicts a portion of the biological sample. The image may include a whole-slide image, such as a scanned image of H&E-stained FFPE tissue.

At 1304, the analysis engine 115 may determine a plurality of bowel disease indication groups based at least on the plurality of image patches. Each bowel disease indication group of the plurality of bowel disease indication groups corresponds to a subset of the plurality of image patches.

In some embodiments, the subset of the plurality of image patches includes a common pixel-wise feature of one or more pixel-wise features. For example, the subset of the plurality of image patches may be formed by at least clustering one or more similar image patches of the plurality of image patches based at least on one or more pixel-wise features. The analysis engine 115 may perform the clustering by applying a cluster analysis technique. The cluster analysis technique may include one or more of a k-means clustering, a mean-shift clustering, a density-based spatial clustering of applications with noise (DBSCAN), an expectation-maximization (EM) clustering using Gaussian mixture models (GMM), and an agglomerative hierarchical clustering. In some embodiments, a GNN may be employed to cluster spatial tabular data to predict categorical scores.

The pixel-wise features may be associated with a particular pixel of the image. The pixel-wise features may include a shape, a color, a size, a presence of a dye, an intensity, and/or the like, associated with the particular pixel of the image of the biological sample. The pixel-wise features may indicate a presence in the biological sample of at least one of an erosion of tissue, a neutrophil, a lymphoid structure, a crypt abscess, and/or debris within an epithelium of the tissue.

At 1304, the analysis engine 115 generates a group-level histological score for each bowel disease indication group of the plurality of bowel disease indication groups, based at least on the subset of the plurality of image patches contained in each respective group. The group-level histological score is at least one of a Nancy Histological Index (NHI) score, a Robarts Histopathology Index (RHI) score, a Geboes Scale score, and a Global Histology Activity Score (GHAS). Additionally and/or alternatively, the group-level histological score is at least one of a first score indicating an absence of disease burden in the intestine of the patient, a second score indicating a mild disease burden in the intestine of the patient, and a third score indicating a moderate disease burden in the intestine of the patient. The scores may range from 0-4 (or other scale depending on the scoring system). In an example, the first score is 0, the second score is 1, and the third score is 2.

The analysis engine 115 may generate the group-level histological score by at least applying at least one machine learning model to predict the histological score for each bowel disease indication group of image patches. The at least one machine learning model, which may include a multiple instance learning (MIL) model, among other models, may be trained to generate the group-level histological score by at least determining a representational encoding of the subset of the plurality of image patches. In some embodiments, the at least one machine learning model is trained on the cell segmentation labels and tissue region segmentation labels generated by the segmentation engine 116. For example, process 1200 or a similar process may be used for cell-segmentation and/or tissue region segmentation.

In some embodiments, the group-level histological score is generated while determining the representational encoding of the subset of the plurality of image patches. For example, the analysis engine 115 may assign a higher attention score to a first image patch of the subset of the plurality of image patches than a second image patch of the subset of the plurality of image patches based at least on the presence of the first pixel-wise feature or the absence of the first pixel-wise feature. The higher attention score indicates that a first pixel-wise feature of the first image patch contributes more to the representational encoding of the subset of the plurality of image patches than the second patch.

Additionally and/or alternatively, the analysis engine 115 generates the group-level histological score based at least on one or more of a quantity of the one or more pixel-wise features within the subset of the plurality of image patches and a distribution of the one or more pixel-wise features within the subset of the plurality of image patches. In some embodiments, a presence of a first pixel-wise feature of the one or more pixel-wise features in the plurality of image patches is associated with a first possible histological score and an absence of the first pixel-wise feature is associated with a second possible histological score. Thus, the presence and/or absence, the quantity, and/or the distribution of the pixel-wise features within the subset of the plurality of image patches may be used to generate the histological score.

At 1306, the analysis engine 115 generates an aggregated histological score for the biological sample based on the generated group-level histological score for each bowel disease indication group. The aggregated histological score is indicative of a disease burden in the intestine of the patient. The aggregated histological score is the overall score predicted for the image of the microscope slide.

The aggregated histological score is at least one of a Nancy Histological Index (NHI) score, a Robarts Histopathology Index (RHI) score, a Geboes Scale score, and a Global Histology Activity Score (GHAS). Additionally, and/or alternatively, the aggregated histological score is at least one of a first score indicating a low disease burden in the intestine of the patient, a second score indicating a moderate disease burden in the intestine of the patient, and a third score indicating a high disease burden in the intestine of the patient. The scores may range from 0-4 (or other scale depending on the scoring system). In an example, the first score is 1, the second score is 2 or 3, and the third score is 4.

In some embodiments, the analysis engine 115 generates a first visual representation of a reduced dimension representation of the plurality of image patches. The first visual representation may include one or more visual indicators (e.g., overlays, colors, masks, etc.). The one or more visual indicators may show the different pixel-wise features. The one or more visual indicators may indicate a contribution of a pixel-wise feature to a possible group-level histological score. The one or more visual indicators provide a visual differentiation between image patches of the plurality of image patches indicating different possible histological scores.

The analysis engine 115 may generate the first visual representation by at least applying a dimensionality reduction technique to a pixel-wise representation of each image patch of the plurality of image patches. The dimensionality reduction technique includes one or more of a principal component analysis (PCA), a uniform manifold approximation and projection (UMAP), and a T-distributed Stochastic Neighbor Embedding (t-SNE). Further still, a GNN can be used to reduce the dimensionality of the spatial tabular data by detecting patterns and relationships in the multidimensional data sets.

Accordingly, the digital pathology platform 110 may efficiently generate reproducible and consistent aggregated histological scores for biological samples. The reproducible and consistent aggregated histological scores may be generated according to embodiments described herein, while limiting or eliminating the subjectivity that has previously reduced the reliability of such histological scores.

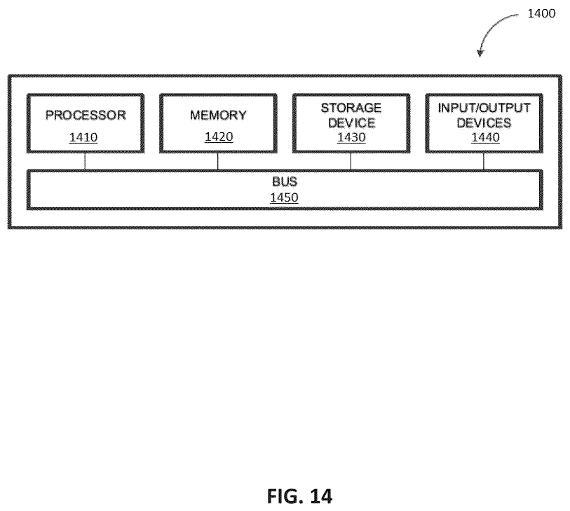

FIG. 14 depicts a block diagram illustrating an example of computing system 1400, in accordance with some example embodiments. Referring to FIGS. 1 and 14, the computing system 1400 may be used to implement the digital pathology platform 110, the client device 130, the analysis engine 115, the segmentation engine 116, and/or any components therein.

As shown in FIG. 14, the computing system 1400 can include a processor 1410, a memory 1420, a storage device 1430, and input/output device 1440. The processor 1410, the memory 1420, the storage device 1430, and the input/output device 1440 can be interconnected via a system bus 1450. The processor 1410 is capable of processing instructions for execution within the computing system 1400. Such executed instructions can implement one or more components of, for example, the digital pathology platform 110, the client device 130, the analysis engine 115, the segmentation engine 116, and/or the like. In some example embodiments, the processor 1410 can be a single-threaded processor. Alternately, the processor 1410 can be a multi-threaded processor. The processor 1410 is capable of processing instructions stored in the memory 1420 and/or on the storage device 1430 to display graphical information for a user interface provided via the input/output device 1440.

The memory 1420 is a computer readable medium such as volatile or non-volatile that stores information within the computing system 1400. The memory 1420 can store data structures representing configuration object databases, for example. The storage device 1430 is capable of providing persistent storage for the computing system 1400. The storage device 1430 can be a floppy disk device, a hard disk device, an optical disk device, or a tape device, or other suitable persistent storage means. The input/output device 1440 provides input/output operations for the computing system 1400. In some example embodiments, the input/output device 1440 includes a keyboard and/or pointing device. In various implementations, the input/output device 1440 includes a display unit for displaying graphical user interfaces.

According to some example embodiments, the input/output device 1440 can provide input/output operations for a network device. For example, the input/output device 1440 can include Ethernet ports or other networking ports to communicate with one or more wired and/or wireless networks (e.g., a local area network (LAN), a wide area network (WAN), the Internet).

In some example embodiments, the computing system 1400 can be used to execute various interactive computer software applications that can be used for organization, analysis and/or storage of data in various formats. Alternatively, the computing system 1400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1440. The user interface can be generated and presented to a user by the computing system 1400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
determining, within an image of a biological sample from an intestine of a patient, a plurality of image patches, wherein each image patch of the plurality of image patches depicts a portion of the biological sample;
determining a plurality of bowel disease indication groups based at least on the plurality of image patches, wherein each bowel disease indication group of the plurality of bowel disease indication groups corresponding to a subset of the plurality of image patches;
generating a group-level histological score for each bowel disease indication group of the plurality of bowel disease indication groups based at least on the subset of the plurality of image patches contained in each respective group; and
generating an aggregated histological score for the biological sample based on the generated group-level histological score for each bowel disease indication group, wherein the aggregated histological score is indicative of a disease burden in the intestine of the patient.

2. The method of claim 1, wherein the group-level histological score and the aggregated histological score are each one of a Nancy Histological Index (NHI) score, a Robarts Histopathology Index (RHI) score, a Geboes Scale score, and a Global Histology Activity Score (GHAS).

3. The method of claim 1 or claim 2, wherein the group-level histological score and the aggregated histological score is at least one of a first score indicating no disease burden, a second score indicating low disease burden in the intestine of the patient, a third score indicating a moderate disease burden in the intestine of the patient, and a fourth score indicating a high disease burden in the intestine of the patient.

4. The method of any one of claims 1-3, wherein the subset of the plurality of image patches is formed by at least clustering one or more similar image patches of the plurality of image patches based at least on one or more pixel-wise features.

5. The method of claim 4, wherein a presence of a first pixel-wise feature of the one or more pixel-wise features in the plurality of image patches is associated with a first possible histological score; and wherein an absence of the first pixel-wise feature is associated with a second possible histological score.

6. The method of claim 5, wherein the generating the group-level histological score comprises assigning a higher attention score to a first image patch of the subset of the plurality of image patches than a second image patch of the subset of the plurality of image patches based at least on the presence of the first pixel-wise feature or the absence of the first pixel-wise feature; and wherein the group-level histological score is generated while determining a representational encoding of the subset of the plurality of image patches.

7. The method of claim 6, wherein the higher attention score indicates that a first pixel-wise feature of the first image patch contributes more to the representational encoding of the subset of the plurality of image patches than the second patch.

8. The method of claim 4, wherein the one or more pixel-wise features is representative of a presence in the biological sample of at least one of an erosion of tissue, a neutrophil, a lymphoid structure, a crypt abscess, and debris within an epithelium of the tissue.

9. The method of claim 4, wherein the one or more pixel-wise features includes at least one of a shape, a color, a size, a presence of a dye, and an intensity associated with a pixel of the image of the biological sample.

10. The method of claim 4, wherein the subset of the plurality of image patches includes a common pixel-wise feature of the one or more pixel-wise features.

11. The method of claim 4, wherein the group-level histological score is generated based at least on one or more of a quantity of the one or more pixel-wise features within the subset of the plurality of image patches and a distribution of the one or more pixel-wise features within the subset of the plurality of image patches.

12. The method of claim 4, wherein the clustering is performed by applying a cluster analysis technique.

13. The method of claim 12, wherein the cluster analysis technique includes one or more of a k-means clustering, a mean-shift clustering, a density-based spatial clustering of applications with noise (DBSCAN), an expectation-maximization (EM) clustering using Gaussian mixture models (GMM), and an agglomerative hierarchical clustering.

14. The method of any one of claims 1-13, further comprising generating a first visual representation of a reduced dimension representation of the plurality of image patches.

15. The method of claim 14, wherein the first visual representation includes one or more visual indicators configured to indicate a contribution of a pixel-wise feature to a possible group-level histological score.

16. The method of claim 14, wherein the first visual representation includes one or more visual indicators configured to provide a visual differentiation between image patches of the plurality of image patches indicating different possible histological scores.

17. The method of claim 14, wherein the first visual representation is generated by at least applying, to a pixel-wise representation of each image patch of the plurality of image patches, a dimensionality reduction technique.

18. The method of claim 17, wherein the dimensionality reduction technique includes one or more of a principal component analysis (PCA), a uniform manifold approximation and projection (UMAP), and a T-distributed Stochastic Neighbor Embedding (t-SNE).

19. The method of any one of claims 1-18, wherein the group-level histological score and the aggregated histological score are each generated by applying at least one machine learning model trained to generate the group-level histological score and the aggregated histological score by at least determining a representational encoding of the subset of the plurality of image patches.

20. The method of claim 19, wherein the at least one machine learning model includes a multiple instance learning (MIL) model.

21. A system, comprising:
at least one data processor; and
at least one memory storing instructions, which when executed by the at least one data processor, cause the at least one data processor to:
determine, within an image of a biological sample from an intestine of a patient, a plurality of image patches, wherein each image patch of the plurality of image patches depicts a portion of the biological sample;
determine a plurality of bowel disease indication groups based at least on the plurality of image patches, wherein each bowel disease indication group of the plurality of bowel disease indication groups corresponding to a subset of the plurality of image patches;
generate a group-level histological score for each bowel disease indication group of the plurality of bowel disease indication groups based at least on the subset of the plurality of image patches contained in each respective group; and
generate an aggregated histological score for the biological sample based on the generated group-level histological score for each bowel disease indication group, wherein the aggregated histological score is indicative of a disease burden in the intestine of the patient.

22. A non-transitory computer-readable medium storing instructions, which when executed by at least one data processor, effectuate operations comprising:
determining, within an image of a biological sample from an intestine of a patient, a plurality of image patches, wherein each image patch of the plurality of image patches depicts a portion of the biological sample;
determining a plurality of bowel disease indication groups based at least on the plurality of image patches, wherein each bowel disease indication group of the plurality of bowel disease indication groups corresponding to a subset of the plurality of image patches;
generating a group-level histological score for each bowel disease indication group of the plurality of bowel disease indication groups based at least on the subset of the plurality of image patches contained in each respective group; and
generating an aggregated histological score for the biological sample based on the generated group-level histological score for each bowel disease indication group, wherein the aggregated histological score is indicative of a disease burden in the intestine of the patient.

23. A computer-implemented method, comprising:
receiving an image of a biological sample from an intestine of a patient, the image depicting a plurality of cells of the biological sample;
segmenting the received image, into a plurality of portions, each portion of the plurality of portions corresponding to one cell of the plurality of cells;
identifying, based at least on the segmented image, a first spatial coordinate associated with each cell of the plurality of cells within the image;
identifying a first cell type associated with the first spatial coordinate; and
generating, based at least on the first spatial coordinate and the first cell type, a visual representation including the image of the biological sample.

24. The method of claim 23, wherein the identifying is further based at least on a plurality of annotations identifying a plurality of cell types depicted in a plurality of images of biological samples.

25. The method of claim 23 or claim 24, wherein the first cell type is at least one of a neutrophil, a plasma cell, a lymphocyte, an intraepithelial lymphocyte, an eosinophil, a Mast cell, a macrophage, a goblet cell, an enterocyte, an endothelial cell, a fibroblast, a smooth muscle cell, and an endothelial cell.

26. The method of any one of claims 23-25, wherein the image further depicts a plurality of tissue regions of the biological sample.

27. The method of claim 26, further comprising: identifying, based at least on the segmented image, a second spatial coordinate associated with each tissue region of the plurality of tissue regions and a first tissue region type associated with the second spatial coordinate.

28. The method of claim 27, further comprising: generating, based at least on the second spatial coordinate and the first tissue region type, a second visual representation including the image of the biological sample.

29. The method of claim 27, wherein the tissue region type is at least one of an epithelium, a mucosa, a submucosa, a normal crypt, an infiltrated crypt, a lumen, a blood vessel, a lymphatic vessel, a lamina propria, a muscularis mucosa, a basal plasmacytosis, an ulcer, an erosion, a granulation tissue, an infiltrated crypt, a crypt abscess, a normal collagen, an abnormal collagen, a stroma, a subtype of stroma, a hyperplastic muscle, a fissure, an abscess, a normal adipose, an abnormal adipose, a serosa, and a serositis.

30. The method of claim 27, wherein the identifying the second spatial coordinate and the first tissue region type is further based at least on a second plurality of annotations identifying a plurality of tissue region types depicted in a plurality of images of biological samples.

31. The method of any one of claims 23-30, wherein the identifying includes generating a metric indicating a confidence level associated with the identified first cell type for each cell of the plurality of cells.

32. The method of any one of claims 23-31, further comprising: generating spatial tabular data including the first spatial coordinate associated with each cell of the plurality of cells within the image and the first cell type associated with the first spatial coordinate.

33. The method of any one of claims 23-32, further comprising: generating a histological score for the biological sample based at least on the first spatial coordinate and the first cell type associated with the first spatial coordinate, wherein the histological score is indicative of a disease burden in the intestine of the patient.

34. The method of claim 33, wherein the histological score is one of a Nancy Histological Index (NHI) score, a Robarts Histopathology Index (RHI) score, a Geboes Scale score, a Global Histology Activity Score (GHAS), a muscle hyperplasia score, and a fibrosis score.

35. The method of claim 33, wherein the first cell type includes a neutrophil.

36. The method of claim 33, wherein the histological score is further generated based on a spatial distribution of the plurality of cells identified as having the first cell type.

37. The method of claim 33, wherein the histological score is further generated based on a quantity of cells of the plurality of cells identified as having the first cell type meeting a threshold quantity of cells.

38. The method of claim 33, wherein the histological score is further generated based on a tissue region type of a plurality of tissue regions depicted in the image.

39. The method of claim 38, wherein the tissue region type is at least one of an erosion and an ulceration.

40. The method of any one of claims 23-39, wherein the first spatial coordinate is two-dimensional.

41. The method of any one of claims 23-40, further comprising: generating, based at least on the first spatial coordinate and the first cell type, an overlay indicating the first cell type at the first spatial coordinate; wherein the overlay includes at least one of a mask, a color, and a pattern.

42. The method of any one of claims 23-41, wherein the image is segmented by applying a machine learning model trained to perform per-cell segmentation and per-tissue region segmentation by at least assigning, to each pixel in the image, a cell segmentation label indicating whether the pixel is associated with a cell type of a cell depicted in the image and a tissue region label indicating whether the pixel is associated with a tissue region type of a tissue region depicted in the image.

43. A system, comprising:
at least one data processor; and
at least one memory storing instructions, which when executed by the at least one data processor, cause the at least one data processor to:
receive an image of a biological sample from an intestine of a patient, the image depicting a plurality of cells of the biological sample;
segment the received image, into a plurality of portions, each portion of the plurality of portions corresponding to one cell of the plurality of cells;
identify, based at least on the segmented image, a first spatial coordinate associated with each cell of the plurality of cells within the image;
identify a first cell type associated with the first spatial coordinate; and
generate, based at least on the first spatial coordinate and the first cell type, a visual representation including the image of the biological sample.

44. A non-transitory computer-readable medium storing instructions, which when executed by at least one data processor, effectuate operations comprising:
receiving an image of a biological sample from an intestine of a patient, the image depicting a plurality of cells of the biological sample;
segmenting the received image, into a plurality of portions, each portion of the plurality of portions corresponding to one cell of the plurality of cells;
identifying, based at least on the segmented image, a first spatial coordinate associated with each cell of the plurality of cells within the image;
identifying a first cell type associated with the first spatial coordinate; and
generating, based at least on the first spatial coordinate and the first cell type, a visual representation including the image of the biological sample.
